(19) United States
(12) Patent Application Publication
(10) Pub. No.: US 2026/0027834 A1
(43) Pub. Date: Jan. 29, 2026

(54) IMAGE FORMING APPARATUS THAT CONTROLS SUPPLY OF CONSUMABLE MATERIAL FROM CONSUMABLE CARRIER

(71) Applicant: KYOCERA Document Solutions Inc., Osaka (JP)

(72) Inventor: Kentaro TESHIMA, Osaka (JP)

(73) Assignee: KYOCERA Document Solutions Inc., Osaka (JP)

(21) Appl. No.: 19/267,499

(22) Filed: Jul. 12, 2025

(30) Foreign Application Priority Data
Jul. 29, 2024 (JP) 2024-122442

(51) Int. Cl. B41J 2/175; B41J 2/165; G03G 15/08

(52) U.S. Cl. CPC B41J 2/17546; B41J 2/16552; B41J 2/16579; G03G 15/0848; G03G 15/0863; G03G 2215/0695

(57) ABSTRACT

A controller of an image forming apparatus causes one of ink containers to supply ink, and acquires an expiry date of consumption of the ink contained in the one ink container. The controller decides whether the expiry date of consumption of the ink has been exceeded, through comparison between the expiry date of consumption of the ink, and a date and time that the expiry date of consumption has been acquired, and stops the supply of the ink from the one consumable carrier, upon deciding that the expiry date of consumption of the ink has been exceeded, and causes another consumable carrier, selected from the consumable carriers other than the one consumable carrier, to supply the consumable material.

### INCORPORATION BY REFERENCE

This application claims priority to Japanese Patent Application No. 2024-122442 filed on Jul. 29, 2024, the entire contents of which are incorporated by reference herein.

### BACKGROUND

The present disclosure relates to an image forming apparatus that uses a consumable material such as toner or ink, and in particular to a technique to supply the consumable material from another consumable carrier, when the expiry date of consumption of the consumable material stored in the original consumable carrier is exceeded.

Existing image forming apparatuses can be broadly classified into ink jet image forming apparatuses that eject ink onto a recording sheet, thereby forming an image thereon, and electrophotographic image forming apparatuses that stick toner onto the recording sheet, thereby forming an image thereon. The ink jet image forming apparatus includes ink containers storing therein the ink, and the ink container is replaced when the remainder of the ink in the ink container becomes scarce. The electrophotographic image forming apparatus includes toner containers storing therein the toner, and the toner container is replaced when the remainder of the toner in the toner container becomes scarce.

Some printing apparatuses include a decision device that decides, with respect to a consumable material, whether the recommended use-by date of the ink cartridge has been exceeded, on the basis of the recommended use-by date calculated from the date manufactured and the recommended stoppage period, and the days elapsed after the date manufactured of the ink cartridge. Such printing apparatus also includes a notification device that displays a message indicating that the expiry date of the ink cartridge is close at hand, on an operation panel when the power to the ink jet printing apparatus is turned on, in the case where the decision device decides that the recommended use-by date has been exceeded, and that a warning cycle has elapsed after the immediately previous warning, on the basis of the warning information and the warning cycle stored in the memory of the ink cartridge. Such an arrangement enables the user to be aware that the expiry date of the ink cartridge is close at hand, without making the user feel annoyed.

### SUMMARY

The disclosure proposes further improvement of the foregoing technique.

In an aspect, the disclosure provides an image forming apparatus including a supply mechanism, an image forming device, a control device, and a data acquirer. The supply mechanism includes a plurality of consumable carriers mounted thereon, each containing a consumable material, and supplies the consumable material from each of the consumable carriers. The image forming device forms an image on a recording medium, with the consumable material supplied by the supply mechanism from the consumable carrier. The control device includes a processor, and acts, when the processor executes a control program, as a controller that causes the supply mechanism to supply the consumable material to the image forming device, from one of the consumable carriers. The data acquirer acquires an expiry date of consumption of the consumable carrier from which the consumable material is being supplied. The controller decides whether the expiry date of consumption of the consumable carrier has been exceeded, through comparison between the expiry date of consumption of the consumable carrier acquired by the data acquirer, and a date and time that the expiry date of consumption has been acquired, and causes the consumable carrier currently supplying the consumable material to stop supplying the consumable material, upon deciding that the expiry date of consumption of the consumable carrier has been exceeded, and causes another consumable carrier, selected from the consumable carriers other than the consumable carrier that has stopped supplying the consumable material, to supply the consumable material.

### BRIEF DESCRIPTION OF THE DRAWINGS

FIG. 1 is a cross-sectional view showing an image forming apparatus according to a first embodiment of the disclosure;

FIG. 2 is a block diagram showing an essential internal configuration of the image forming apparatus according to the first embodiment;

FIG. 3 is a flowchart showing a control process for stopping supply of ink from one of two ink containers that supply the ink of the same color, and starting the supply of the ink from the other ink container;

FIG. 4 is a cross-sectional view showing an image forming apparatus according to a second embodiment of the disclosure; and

FIG. 5 is a block diagram showing an essential internal configuration of the image forming apparatus according to the second embodiment.

### DETAILED DESCRIPTION

Hereafter, an image forming apparatus according to some embodiments of the disclosure will be described, with reference to the drawings.

### First Embodiment

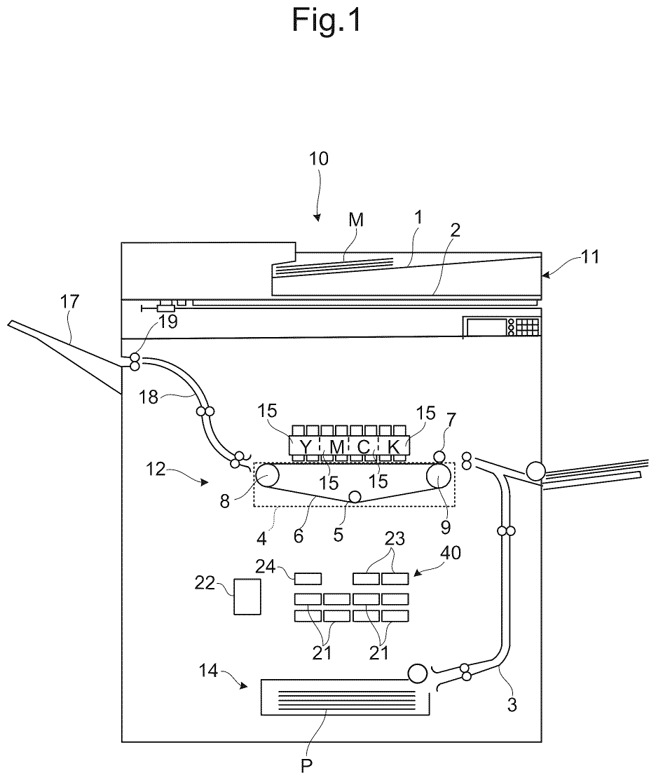

FIG. 1 is a cross-sectional view showing an image forming apparatus according to a first embodiment of the disclosure. As shown in FIG. 1, the image forming apparatus 10 is a multifunction peripheral (MFP) having a plurality of functions, such as copying and scanning. The image forming apparatus 10 includes an image reading device 11 and an image forming device 12.

The image reading device 11 includes, for example, a contact image sensor (CIS), as an image sensor for optically reading the image of a document M. The CIS outputs the image data representing the image of the document M.

The image forming device 12 receives an input of the image data representing the image of the document M, and forms the image of the document M represented by the image data, on a recording sheet by an ink jet printing method. The image forming device 12 includes ink containers 21 respectively containing ink of four colors, namely black, cyan, magenta, and yellow, and line heads 15 that respectively eject ink of the four colors, supplied from the corresponding ink container 21. The line heads 15 each eject the ink droplets of the corresponding color onto the recording sheet P, delivered to a conveying unit 4 from a sheet feeding device 14 through a first transport route 3, thereby forming a color image on the recording sheet P.

The ink containers 21, containing the ink of the respective colors, are mounted on the supply mechanism 40. The supply mechanism 40 causes each of the plurality of ink containers 21 to supply the ink. The supply mechanism 40 includes a supply path for conducting the ink supplied from the ink container 21 to the image forming device 12, and a discharge device that discharges the ink remaining on the supply path. In the supply mechanism 40, two ink containers 21 each containing the ink of the same color are provided for each of the lineheads 15 that eject the ink droplets of the respective colors. The supply mechanism 40 supplies the ink to the linehead 15, from one of the two ink containers 21.

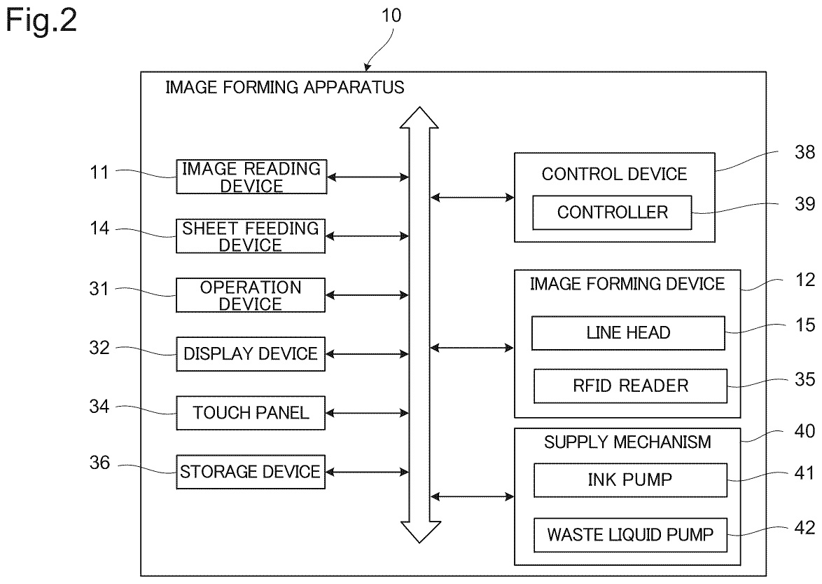

The supply mechanism 40 includes an ink pump 41 (see FIG. 2), in each of two supply paths for supplying the ink to the linehead 15 from the respective ink containers 21 containing the ink of the same color, with respect to each of the colors. The supply mechanism 40 supplies the ink to the linehead 15 through the supply path, from one of the two ink containers 21 containing the ink of the same color, by activating one of the two ink pumps 41.

The supply mechanism 40 also includes a waste liquid container 22 for storing waste ink, and a waste liquid pump 42, as the discharge device of the ink. In the waste liquid container 22, the ink remaining on the supply paths is collected and stored. For example, the waste liquid pumps 42 (see FIG. 2) are connected to the respective supply paths. The supply mechanism 40 activates the waste liquid pump 42 connected to one of the supply paths, thereby sucking the ink remaining on the corresponding supply path, and conducts such ink to the waste liquid container 22, to be deposited therein. The mentioned components of the supply mechanism 40 are controlled by a controller 39 (see FIG. 2).

Further, the supply mechanism 40 includes two cleaning liquid containers 23, each containing a cleaning liquid for cleaning the lineheads 15, and a maintenance liquid container 24, containing a maintenance liquid used for the maintenance work for the lineheads 15.

The conveying unit 4 includes a drive roller 8, a follower roller 9, a tension roller 5, and a conveying belt 6. The conveying belt 6 is an endless belt stretched around the drive roller 8, the follower roller 9, and the tension roller 5. The drive roller 8 is driven by a non-illustrated motor so as to rotate counterclockwise. When the drive roller 8 is made to rotate, the conveying belt 6 revolves counterclockwise, and the follower roller 9 and the tension roller 5 are each passively made to rotate counterclockwise, by the conveying belt 6.

The tension roller 5 serves to maintain the tension of the conveying belt 6 at an appropriate level. The conveying belt 6 is in contact with an adsorption roller 7. The adsorption roller 7 electrically charges the transport belt 6, to thereby electrostatically adsorb the recording sheet P delivered from the sheet feeding device 14, to the conveying belt 6.

After the image of the document is formed on the recording sheet P by the image forming device 12, the recording sheet P is delivered to an output tray 17 from a delivery roller pair 19, through a transport route 18.

FIG. 2 is a block diagram showing an internal configuration of the image forming apparatus 10. As shown in FIG. 2, the image forming apparatus 10 includes the image reading device 11, the image forming device 12, a sheet feeding device 14, an operation device 31, a display device 32, a touch panel 34, a storage device 36, and a control device 38. The cited components are configured to transmit and receive data and signals to and from each other, via a bus.

The image forming device 12 includes the lineheads 15 and radio frequency identification (RFID) readers 35, and the supply mechanism 40 includes the ink pumps 41 and the waste liquid pumps 42.

The RFID readers 35 (exemplifying the data acquirer in the disclosure) are each provided at the position where the ink container 21 is mounted, to read information TD about the ink container 21 from a non-illustrated RFID tag of the corresponding ink container 21. The RFID tag is provided on each of the ink containers 21, and the information TD about the ink container 21 is stored in the RFID tag. The information TD about the ink container 21 includes, for example, (1) expiry date of consumption SK of the ink, or (2) date manufactured SZ of the consumable material, and warranty period HK.

The ink pumps 41 are, as described above, respectively provided in the two supply paths, for transporting and supplying the ink to one of the lineheads 15, from the two ink containers 21 storing the ink of the same color, with respect to each of the colors. When one of the ink pumps 41 respectively provided in the two supply paths is activated, the ink is supplied to the linehead 15, from one of the two ink containers 21 storing the ink of the same color.

The waste liquid pumps 42 each conduct the ink remaining in the corresponding supply path to the waste liquid container 22, to deposit the ink therein.

The operation device 31 includes physical keys such as a numeric keypad, an enter key, and a start key. The display device 32 is, for example, constituted of a liquid crystal display (LCD) or an organic light-emitting diode (OLED) display.

A touch panel 34 is overlaid on the screen of the display device 32. The touch panel 34 is based on what is known as a resistive film or electrostatic capacitance. The touch panel 34 detects a contact (touch) of the user's finger made thereon, along with the touched position, and outputs a detection signal indicating the coordinate of the touched position, to the controller 39 of the control device 38.

The storage device 36 is a large-capacity storage device such as a solid-state drive (SSD) or a hard disk drive (HDD), and contains various application programs and various types of data.

The control device 38 includes a processor, a random-access memory (RAM), a read-only memory (ROM), and so forth. The processor is, for example, a central processing unit (CPU), an application specific integrated circuit (ASIC), or a micro processing unit (MPU). The control device 38 serves as the controller 39, when the processor executes a control program stored in the ROM or the storage device 36.

The controller 39 executes overall control of the image forming apparatus 10. The controller 31 is connected to the image reading device 11, the image forming device 12, the operation device 31, the display device 32, the touch panel 34, and the storage device 36. The controller 39 controls the operation of the components cited above, and transmits and receives signals and data to and from those components.

The controller 39 acts as a processing device that executes various processings necessary for the image forming job by the image forming apparatus 10. In addition, the controller 39 accepts instructions to execute an operation, inputted by the user, on the basis of a detection signal outputted from the touch panel 34, or an operation performed on the physical key of the operation device 31. For example, the controller 39 accepts a user's touch operation made through the touch panel 34, on a graphical user interface (GUI) displayed on the screen of the display device 32. The controller 39 is also configured to control the displaying operation of the display device 32.

Further, the controller 39 controls each of the lineheads 15 of the image forming device 12, to activate or stop the operation of the lineheads 15. The controller 39 also activates one of the two ink pumps 41 respectively provided in the two supply paths, for transporting and supplying the ink to one of the lineheads 15, from the two ink containers 21 storing the ink of the same color, with respect to each of the colors. In addition, the controller 39 activates the waste liquid pump 42 connected to one of the supply paths, thereby sucking the ink remaining in the corresponding supply path, and depositing such residual ink in the waste liquid container 22.

Here, the ink container 21 corresponds to the consumable carrier in the disclosure, and the ink in the ink container 21 corresponds to the consumable material in the disclosure.

In the image forming apparatus 10 configured as above, (1) the expiry date of consumption SK of the ink, or (2) the date manufactured SZ and the warranty period HK of the consumable material, is specified in advance, with respect to each of the ink containers 21. Unless the use of the ink is stopped according to the expiry date of consumption SK, or the date manufactured SZ and the warranty period HK of the consumable material, the quality of the image formed of the ink may be degraded.

Conventionally, however, simply a warning indicating that the expiry date of consumption of the ink has been exceeded is displayed, on the basis of the expiry date of consumption SK of the ink in the ink container 21, or the date manufactured SZ and the warranty period HK of the ink. Therefore, the replacement of the ink container 21 may be delayed, which may lead to degradation in image quality.

In the image forming apparatus 10 according to this embodiment, therefore, two ink containers 21 are provided for each of the colors, and the controller 39 is controlling the supply mechanism 40 to supply the ink to the linehead 15, from one of the two ink containers 21 storing the ink of the same color. When the expiry date of consumption of the ink in one of the two ink containers 21 is exceeded, the controller 39 causes the one ink container 21 to stop supplying the ink, and causes the other of the two ink containers 21, the expiry date of consumption of which has not yet been exceeded, to start supplying the ink.

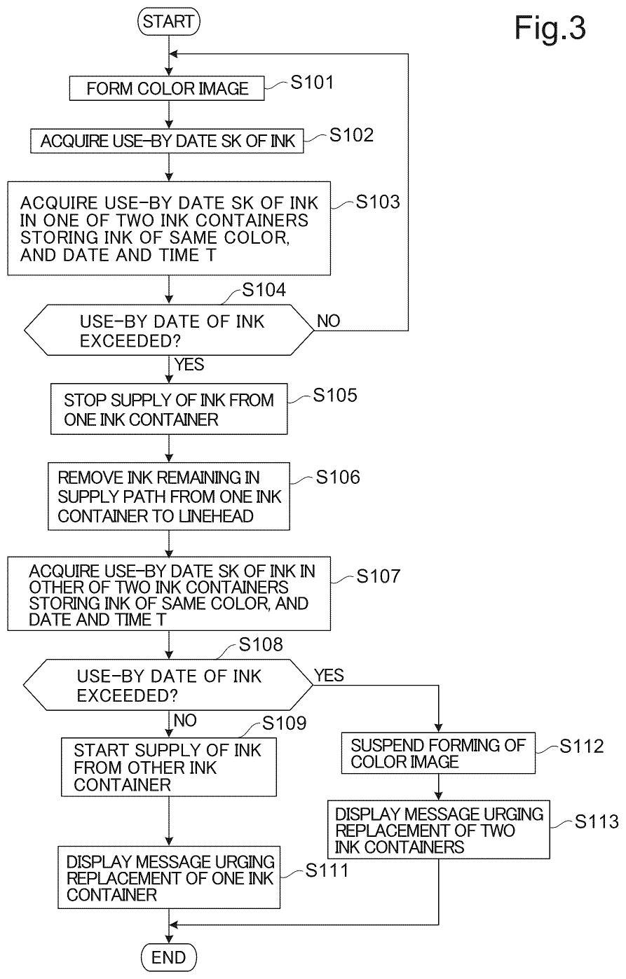

Referring now to a flowchart shown in FIG. 3, a control process for stopping the supply of the ink from one of the two ink containers 21 storing the ink of the same color, and starting the supply of the ink from the other ink container 21, will be described in detail.

To be more specific, black ink is stored in two ink containers 21, cyan ink is stored in two ink containers 21, magenta ink is stored in two ink containers 21, and yellow ink is stored in two ink containers 21. The controller 39 activates the ink pump 41, to transport and supply the ink to the linehead 15, from one of the two ink containers 21 storing the ink of the same color, with respect to the ink of each color, and controls each of the lineheads 15 so as to eject black ink droplets, cyan ink droplets, magenta ink droplets, and yellow ink droplets, respectively, to start forming a color image on the recording sheet (S101).

As described above, the information TD about the ink container 21 is stored in the RFID tag, provided for each of the ink container 21. The information TD about the ink container 21 indicates (1) the expiry date of consumption SK of the consumable material, or (2) the date manufactured SZ and the warranty period HK of the consumable material. The controller 39 causes the RFID reader 35 to read the information TD about the ink container 21 from the RFID tag of the ink container 21, with respect to each of the ink containers 21, and acquires the expiry date of consumption SK of the ink, or the date manufactured SZ and the warranty period HK of the ink, according to the information TD about the container 21. In the case of acquiring the date manufactured SZ and the warranty period HK of the ink, the controller 39 adds the warranty period HK to the date manufactured SZ of the ink, thereby calculating the expiry date of consumption SK of the ink. In other words, the controller 39 may either acquire the expiry date of consumption SK of the ink, from the information TD about the ink container 21, or calculate the expiry date of consumption SK of the ink, on the basis of the date manufactured SZ and the warranty period HK of the ink, indicated by the information TD about the ink container 21 (S102).

The controller 39 acquires, at the same time as acquiring the expiry date of consumption SK of the ink in one of the two ink containers 21 storing the ink of the same color, with respect to the ink of each color, the date and time T that the expiry date of consumption SK of the corresponding ink has been acquired (S103). The controller 39 then compares between the expiry date of consumption SK of the ink acquired at S102, and the date and time T acquired at S103, thereby deciding whether the expiry date of consumption SK of the ink in the ink container 21 currently supplying the ink has been exceeded, in other words whether expiry date of consumption SK of the ink is earlier than the date and time T (S104).

When the controller 39 decides that the expiry date of consumption SK of the ink in the ink container 21 currently supplying the ink has not been exceeded (No at S104), the operation returns to S101.

In contrast, upon deciding that the expiry date of consumption SK has been exceeded (Yes at S104), the controller 39 stops the operation of the ink pump 41 in the supply path between the ink container 21 currently supplying the ink and the linehead 15, thereby stopping the supply of the ink (S105). The controller 39 then activates the waste liquid pump 42 connected to the corresponding supply path (S106). Accordingly, the ink remaining in the supply path is sucked and removed by the waste liquid pump 42, and then conducted to the waste liquid container 22 to be deposited therein (S106). Therefore, the ink that has exceeded the expiry date of consumption SK can be kept from remaining in the supply path and being put to use.

Further, the controller 39 selects the other ink container 21, storing the ink of the same color as the ink in the ink container 21 thus far supplying the ink, and acquires the expiry date of consumption SK of the ink in the other ink container 21, and also the date and time T that the expiry date of consumption SK of the ink in the other ink container 21 has been acquired (S107). The controller 39 then compares between the expiry date of consumption SK of the corresponding ink and the date and time T, thereby deciding whether the expiry date of consumption SK of the ink in the other ink container 21 has been exceeded, in other words whether expiry date of consumption SK of the ink is earlier than the date and time T (S108).

Upon deciding that the expiry date of consumption SK of the ink in the other ink container 21 has not been exceeded (No at S108), the controller 39 activates the ink pump 41 in the supply path between the other ink container 21 and the linehead 15, thereby starting the supply of the ink from the other ink container 21 (S109). Therefore, the lineheads 15 can continue with ejecting the ink droplets of the corresponding color, thereby continuing with the forming operation of the color image on the recording sheet, without suspending the image forming operation thus far being executed with the ink supplied from the first mentioned ink container 21.

In the case where a time lag arises after the supply of the ink from one of the ink containers 21 is stopped and before the supply of the ink from the other ink container 21 is started, the controller 39 may cause the lineheads 15 to suspend the operation, for the period corresponding to the time lag.

Then the controller 39 causes the display device 32 to display a message urging the user to replace the ink container 21, the expiry date of consumption SK of which has been decided to be exceeded, at S104 (S111).

Upon deciding that the expiry date of consumption SK of the ink in the other ink container 21 has also been exceeded (Yes at S108), the controller 39 stops the operation of the ink pumps 41 for supplying the ink to the linehead 15 from the respective ink containers 21, with respect to the ink of each color, in other words stops the operation of all the ink pumps 41 and all the lineheads 15, thereby suspending the forming operation of the color image on the recording sheet (S112). Then the controller 39 causes the display device 32 to display a message urging the user to replace the ink container 21, the expiry date of consumption SK of which has been decided to be exceeded at S104 and/or S108 (S113). Thereafter, the process is finished.

According to the first embodiment, as described above, two ink containers 21 are provided for each of the colors. When the expiry date of consumption of the ink in one of the two ink containers 21 storing the ink of the same color is exceeded, while the ink is supplied to the linehead 15 from one of the two ink containers 21, the supply of the ink from such one ink container 21 is stopped, and the supply of the ink from the other ink container 21 is started, provided that the expiry date of consumption of the ink in the other ink container 21 has not been exceeded. Therefore, the ink the expiry date of consumption of which has been exceeded can be kept from being continuously used, and the degradation in image quality can be avoided. In addition, suspension of the image forming operation, due to the delay in replacing the ink container 21, can be prevented.

With the image forming apparatus 10 according to the first embodiment, in which the plurality of ink containers 21 each storing the ink are mounted, the supply of the ink from one of the ink containers 21, the expiry date of consumption of which has been exceeded, can be seamlessly switched to the ink from the other ink container 21.

Here, although two ink containers 21 are provided for each color in the first embodiment, the supply mechanism 40 may include three or more ink containers 21 for each color. In this case, the controller 39 causes one of the three or more ink containers 21 of the same color to supply the ink, and when the expiry date of consumption of the ink of this ink container 21 is exceeded, the controller 39 stops the operation of the ink pump 41 in the supply path, for transporting and supplying the ink from the corresponding ink container 21 to the linehead 15, thereby stopping the supply of the ink. Then the controller 39 acquires the expiry date of consumption SK of the ink in the remaining two or more ink containers 21, and also the date and time T that the expiry date of consumption SK of such ink has been acquired, and selects, through comparison between the expiry date of consumption SK of each ink and the corresponding date and time T, the expiry date of consumption SK closest to, and subsequent to, the date and time T, in other words the expiry date of consumption SK not yet reached, and closest to the date and time T. The controller 39 then activates the ink pump 41 in the supply path for transporting and supplying the ink to the linehead 15, from the other ink container 21 storing the ink of the selected expiry date of consumption SK, thereby starting the supply of the ink. Accordingly, the ink from the ink container 21 storing the ink closer to the expiry date of consumption is supplied to the linehead 15. Therefore, the ink in each of the ink containers 21 can be efficiently consumed, without incurring degradation in image quality.

According to the first embodiment, the ink is supplied from one of the two ink containers 21 storing the ink of the same color, and when the expiry date of consumption of the ink from the one ink container 21 is exceeded, the supply of the ink from the one ink container 21 is immediately stopped. Instead, the controller 39 may allow the ink container 21 currently supplying the ink to continue with the supply of the ink until the image forming operation based on the current print job is finished, despite deciding that the expiry date of consumption of the ink in the corresponding ink container 21 has been exceeded, during the image forming operation based on the print job, with the ink being supplied from the corresponding ink container 21 through the linehead 15 of the image forming device 12. Then the controller 39 may select the other ink container 21, different from the ink container 21 thus far supplying the ink, after the image forming operation based on the print job is finished, and supply the ink from the other ink container 21. In this case, the image quality can be maintained at a highest possible level, by supplying the ink from the ink container 21, the expiry date of consumption of which has not been exceeded, without suspending the image forming operation based on the current print job, and affecting the productivity.

According to the first embodiment, further, two cleaning liquid containers 23 are provided, like the two ink containers 21 storing the ink of the same color. Therefore, when the cleaning liquid in one of the cleaning liquid containers 23 reaches the expiry date of consumption, the controller 39 may stop, through similar operation with respect to the ink containers 21, the supply of the cleaning liquid from the one cleaning liquid container 23, and start the supply of the cleaning liquid from the other cleaning liquid container 23, in the case of deciding that the expiry date of consumption of the cleaning liquid in the other cleaning liquid container 23 has not been exceeded.

### Second Embodiment

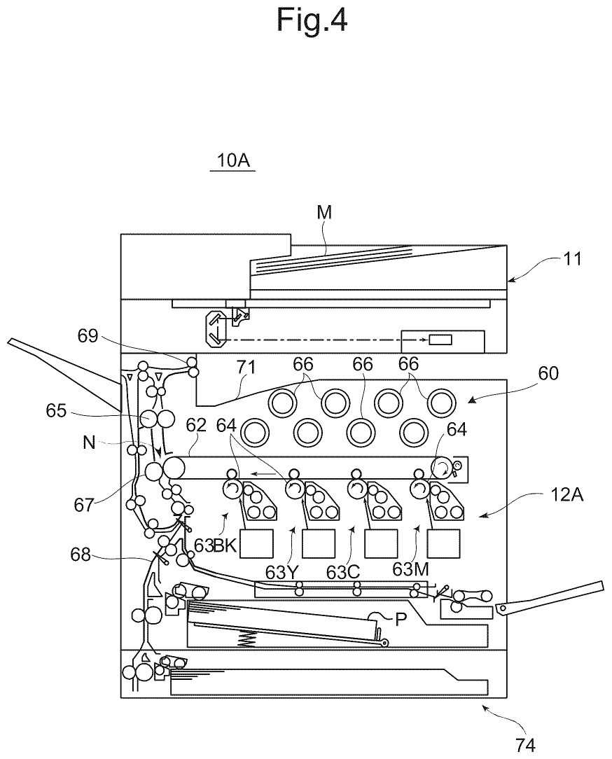

FIG. 4 is a cross-sectional view showing an image forming apparatus according to a second embodiment of the disclosure. The image forming apparatus 10A according to the second embodiment includes the image reading device 11 and an image forming device 12A. The image reading device 11 includes a CIS for optically reading the image of the document M, and the image data representing the image of the document M is outputted from the CIS.

The image forming device 12A receives an input of the image data representing the image of the document, and forms the image of the document represented by the image data, on a recording sheet using toner, by an electrophotographic method. The image forming device 12A includes toner containers 66 respectively containing toner of four colors, namely magenta, cyan, yellow, and black, and an image forming subunit 63M for magenta, an image forming subunit 63C for cyan, an image forming subunit 63Y for yellow, and an image forming subunit 63Bk for black, which form the toner image of the corresponding color, with the toner supplied from the corresponding toner container 66. In each of the image forming subunits 63M, 63C, 63Y, and 63Bk, the surface of a photoconductor drum 64 is uniformly charged and exposed, to thereby form an electrostatic latent image on the surface of the photoconductor drum 64, and then the electrostatic latent image on the surface of the photoconductor drum 64 is developed into a toner image, which is transferred to an intermediate transfer belt 62. As result, a colored toner image is formed on the intermediate transfer belt 62. The colored toner image is transferred, as secondary transfer, to the recording sheet P transported from a sheet feeding device 74 along a transport route 68, at a nip region N between the intermediate transfer belt 62 and a secondary transfer roller 67.

After the image of the document is formed on the recording sheet P, the recording sheet P is heated and pressed by a fixing device 65, so that the toner image on the recording sheet Pis fixed thereto, by thermal compression. Then the recording sheet P is delivered to an output tray 71, through a delivery roller pair 69.

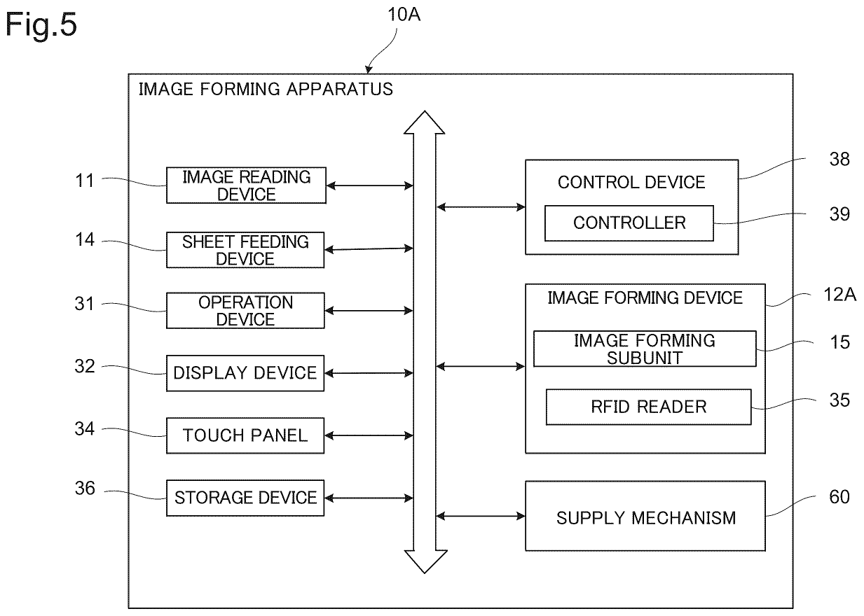

FIG. 5 is a block diagram showing an internal configuration of the image forming apparatus 10A according to the second embodiment. The internal configuration of the image forming apparatus 10A according to the second embodiment is generally the same as that of the image forming apparatus 10 according to the first embodiment shown in FIG. 2. However, the image forming apparatus 10A according to the second embodiment is different from the first embodiment, in including the image forming device 12A based on the electrophotography, instead of the image forming device 12 based on the ink jet process. The controller 39 of the image forming apparatus 10A according to the second embodiment controls the image forming device 12A based on the electrophotography, to form the image of the document on the recording sheet P with the image forming device 12A, through the operation described above.

The electrophotographic image forming apparatus 10A configured as above includes two toner containers 66 (corresponding to the consumable carrier in the disclosure), containing the toner (corresponding to the consumable material in the disclosure) of the same color, provided for each of the image forming subunits 63M, 63C, 63Y, and 63Bk, and a supply mechanism 60 that supplies the toner to each of the image forming subunits, from one of the two toner containers 66. The toner containers 66 are each provided with the non-illustrated RFID tag. The RFID tag contains the information TD indicating the expiry date of consumption SK of the toner in the corresponding toner container 66, or the date manufactured SZ and the warranty period HK of the toner. The controller 39 causes the RFID reader 35 to read the information TD about the toner container 66 from the RFID tag, with respect to each of the toner containers 66, when controlling the image forming device 12A thereby forming the color image on the recording sheet, and acquires the expiry date of consumption SK of the toner, or the date manufactured SZ and the warranty period HK of the toner, indicated by the information TD. In the case of acquiring the date manufactured SZ and the warranty period HK of the toner, the controller 39 adds the warranty period HK to the date manufactured SZ of the toner, thereby calculating the expiry date of consumption SK of the toner.

The controller 39 selects the toner container 66 currently supplying the toner, from the two toner containers 66 storing the toner of the same color, with respect to the toner of each color, and acquires the expiry date of consumption SK of the toner in the selected toner container 66, and also the date and time T that the expiry date of consumption SK of the corresponding toner has been acquired. The controller 39 then compares between the expiry date of consumption SK of the toner, and the date and time T, thereby deciding whether the expiry date of consumption SK of the toner in the toner container 66 currently supplying the toner has been exceeded. Upon deciding that the expiry date of consumption SK has been exceeded, the controller 39 causes the supply mechanism 60 to stop the supply of the toner from the corresponding toner container 66. At this point, the controller 39 may control the supply mechanism 60 to conduct the toner remaining in the toner supply path to a non-illustrated waste toner container, to deposit the toner therein. For example, a screw (corresponding to the discharge device in the disclosure) may be provided inside the supply path, as part of the supply mechanism 60. The controller 39 rotates the screw, thereby conducting the toner remaining in the supply path to the waste toner container.

Further, the controller 39 selects the other toner container 66 storing the toner of the same color as the first mentioned toner container 66, and acquires the expiry date of consumption SK of the toner in the other toner container 66. The controller 39 then decides whether the expiry date of consumption SK of the toner in the other toner container 66 has been exceeded, through comparison between the expiry date of consumption SK of the toner and the date and time T that the expiry date of consumption SK of the toner has been acquired. Upon deciding that the expiry date of consumption SK of the toner in the other toner container 66 has not been exceeded, the controller 39 causes the other toner container 66 to start supplying the toner, thereby continuing with the color image forming operation, including allowing the image forming subunits 63M, 63C, 63Y, and 63Bk to form the toner image of the respective colors, forming the colored toner image on the intermediate transfer belt 62, and transferring the colored toner image from the intermediate transfer belt 62 to the recording sheet.

Thus, also in the electrophotographic image forming apparatus 10A, including the plurality of toner containers 66 mounted therein, the supply of the toner from the toner container 66, the expiry date of consumption of which has been exceeded, can be seamlessly switched to the toner of the other toner container 66, with the configuration and through the operation that are similar to those of the image forming apparatus 10 based on the ink jet process.

In the case of the printing apparatus, simply configured to display the message indicating that the use-by date of the ink cartridge is close at hand, unlike the one according to the foregoing embodiments, the user replaces the ink cartridge with a new one, in view of the message. However, in the case where the user fails to notice the message, the ink cartridge is continuously used, without being replaced. Otherwise, the user is compelled to take the trouble to replace the ink cartridge. In contrast, with the image forming apparatus 10, 10A according to the foregoing embodiments, in which the plurality of consumable carriers containing the consumable material are mounted, the consumable material can be seamlessly supplied from the other consumable carrier, when the expiry date of consumption of the consumable material, in the consumable carrier currently in use, has been exceeded.

Further, the configurations and processings described in the embodiments with reference to FIG. 1 to FIG. 5 are merely exemplary, and in no way intended to limit the disclosure to those configurations and processings.

While the present disclosure has been described in detail with reference to the embodiments thereof, it would be apparent to those skilled in the art that various changes and modifications may be made therein within the scope defined by the appended claims.

What is claimed is:

1. An image forming apparatus comprising:
a supply mechanism that includes a plurality of consumable carriers mounted thereon, each containing a consumable material, and supplies the consumable material from each of the consumable carriers;
an image forming device that forms an image on a recording medium, with the consumable material supplied by the supply mechanism from the consumable carrier;
a control device including a processor, and configured to act, when the processor executes a control program, as a controller that causes the supply mechanism to supply the consumable material to the image forming device, from one of the consumable carriers;
a data acquirer that acquires an expiry date of consumption of the consumable carrier from which the consumable material is being supplied,
wherein the controller decides whether the expiry date of consumption of the consumable carrier has been exceeded, through comparison between the expiry date of consumption of the consumable carrier acquired by the data acquirer, and a date and time that the expiry date of consumption has been acquired, and causes the consumable carrier currently supplying the consumable material to stop supplying the consumable material, upon deciding that the expiry date of consumption of the consumable carrier has been exceeded, and causes another consumable carrier, selected from the consumable carriers other than the consumable carrier that has stopped supplying the consumable material, to supply the consumable material.

2. The image forming apparatus according to claim 1,
wherein, upon selecting the other consumable carrier, and deciding that the expiry date of consumption of the other consumable carrier has not been exceeded, through comparison between the expiry date of consumption of the other consumable carrier acquired by the data acquirer, and the date and time that the expiry date of consumption has been acquired, the controller causes the other consumable carrier to supply the consumable material.

3. The image forming apparatus according to claim 2,
wherein, when a plurality of other consumable carriers are selected, the controller selects the other consumable carrier, the expiry date of consumption of which is closest to, and subsequent to, the date and time that the expiry dates of consumption have been acquired, among the expiry dates of consumption of the consumable materials stored in the plurality of other consumable carriers, and causes the supply mechanism to supply the consumable material from the selected other consumable carrier.

4. The image forming apparatus according to claim 1,
wherein the supply mechanism includes a supply path for supplying the consumable material from the consumable carrier, provided for each of the consumable carriers, and a discharge device that discharges the consumable material remaining in the supply path, and
the controller causes the consumable carrier currently supplying the consumable material to stop supplying the consumable material, upon deciding that the expiry date of consumption of the consumable carrier currently supplying the consumable material has been exceeded, and causes the discharge device to discharge the consumable material remaining in the supply path corresponding to the consumable carrier thus far supplying the consumable material.

5. The image forming apparatus according to claim 1,
wherein, upon deciding that the expiry date of consumption of the consumable carrier currently supplying the consumable material has been exceeded, while causing the image forming device to form an image on a basis of a print job, by supplying the consumable material from the consumable carrier, the controller allows the consumable carrier currently supplying the consumable material to continue with supplying the consumable material, until image forming based on the current print job is finished, selects another consumable carrier than the consumable carrier thus far supplying the consumable material, after the image forming based on the print job is finished, and causes the other consumable carrier to supply the consumable material.

6. The image forming apparatus according to claim 1, further comprising a display device,
wherein the controller causes the display device to display a message urging replacement of the consumable carrier, upon deciding that the expiry date of consumption of the consumable material in the consumable carrier has been exceeded.

7. The image forming apparatus according to claim 1,
wherein the data acquirer includes an RFID reader that reads the expiry date of consumption of the consumable carrier, from an RFID tag provided for each of the consumable carrier, and storing therein the expiry date of consumption of the corresponding consumable carrier.

8. The image forming apparatus according to claim 1,
wherein the image forming device forms an image on a recording sheet with ink, which is the consumable material, through an ink jet process, and
the consumable carrier is an ink container storing therein the ink.

9. The image forming apparatus according to claim 8, further comprising two cleaning liquid containers each containing a cleaning liquid for cleaning a linehead that ejects the ink, provided in the image forming device based on the ink jet process,
wherein, when the expiry date of consumption of the cleaning liquid in one of the cleaning liquid container is exceeded, the controller causes the one cleaning liquid container to stop supplying the cleaning liquid, and causes the other cleaning liquid container to supply the cleaning liquid, in a case of deciding that the expiry date of consumption of the cleaning liquid in the other cleaning liquid container has not been exceeded.

10. The image forming apparatus according to claim 1,
wherein the image forming device forms an image on a recording sheet with toner, which is the consumable material, through an electrophotographic process, and
the consumable carrier is a toner container storing therein the toner.
